(19) United States
(12) Patent Application Publication
(10) Pub. No.: US 2026/0362244 A1
(43) Pub. Date: Nov. 12, 2026

(54) CELL SWITCHING IN WIRELESS COMMUNICATIONS

(71) Applicant: LG ELECTRONICS INC., Seoul (KR)

(72) Inventors: Hongsuk KIM, Seoul (KR); Sunghoon JUNG, Seoul (KR); Sangwon KIM, Seoul (KR); Siyoung CHOI, Seoul (KR)

(73) Assignee: LG ELECTRONICS INC., Seoul (KR)

(21) Appl. No.: 19/123,286

(22) PCT Filed: Nov. 27, 2023
(86) PCT No.: PCT/KR2023/019235

§ 371 Date: Apr. 22, 2025

Related U.S. Application Data
(60) Provisional application No. 63/429,160, filed on Dec. 1, 2022.

(51) Int. Cl. H04W 36/00

(52) U.S. Cl. CPC H04W 36/0058; H04W 36/0072

(57) ABSTRACT

The present disclosure relates to cell switching in wireless communications. According to an embodiment of the present disclosure, when a user equipment (UE) detects a failure on a serving secondary cell (SCell), the UE may identify one or more candidate SCells associated with the serving SCell based on association information, and transmit report information comprising information for some or all of the one or more identified candidate SCells to a network. Therefore, the network can transmit a switching command from the failed serving SCell, thereby pending data transmission can be reduced.

### CROSS-REFERENCE TO RELATED APPLICATIONS

This application is the National Stage filing under 35 U.S.C. 371 of International Application No. PCT/KR2023/019235, filed on Nov. 27, 2023, which claims the benefit of U.S. Provisional Application No. 63/429,160 filed on Dec. 1, 2022, the contents of which are all hereby incorporated by reference herein in their entireties.

### TECHNICAL FIELD

The present disclosure is related to cell switching in wireless communications.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

In wireless communications, a quality of a cell on which a user equipment (UE) performs a transmission/reception may deteriorate due to various reasons. In this case, the UE may need to perform a cell switching to another cell which has better cell quality. The cell switching should be performed timely so that the UE can be provided a service with good quality.

### SUMMARY

An aspect of the present disclosure is to provide method and apparatus for cell switching in a wireless communication system.

According to an embodiment of the present disclosure, a method performed by a user equipment (UE) configured to operate in a wireless communication system comprises: receiving, from a network via a special cell (SpCell), a configuration for one or more candidate secondary cells (SCells), wherein the configuration comprises association information informing one or more SCells associated with a corresponding candidate SCell, and at least one report condition for the corresponding candidate SCell; detecting a failure on a serving SCell; after detecting the failure on the serving SCell, identifying at least one candidate SCell associated with the serving SCell based on the association information; based on a report condition for a candidate SCell among the at least one candidate SCell being satisfied, transmitting report information comprising information for the candidate SCell to the network via the SpCell; receiving, from the network via the SpCell, a switching command to the candidate SCell after transmitting the report information; and applying a configuration for the candidate SCell based on the switching command.

According to an embodiment of the present disclosure, a user equipment (UE) configured to operate in a wireless communication system comprises: at least one transceiver; at least one processor; and at least one memory operatively coupled to the at least one processor and storing instructions that, based on being executed by the at least one processor, perform operations comprising: receiving, from a network via a special cell (SpCell), a configuration for one or more candidate secondary cells (SCells), wherein the configuration comprises association information informing one or more SCells associated with a corresponding candidate SCell, and at least one report condition for the corresponding candidate SCell; detecting a failure on a serving SCell; after detecting the failure on the serving SCell, identifying at least one candidate SCell associated with the serving SCell based on the association information; based on a report condition for a candidate SCell among the at least one candidate SCell being satisfied, transmitting report information comprising information for the candidate SCell to the network via the SpCell; receiving, from the network via the SpCell, a switching command to the candidate SCell after transmitting the report information; and applying a configuration for the candidate SCell based on the switching command.

According to an embodiment of the present disclosure, a network node configured to operate in a wireless communication system comprises: at least one transceiver; at least one processor; and at least one memory operatively coupled to the at least one processor and storing instructions that, based on being executed by the at least one processor, perform operations comprising: transmitting, to a user equipment (UE) via a special cell (SpCell), a configuration for one or more candidate secondary cells (SCells), wherein the configuration comprises association information informing one or more SCells associated with a corresponding candidate SCell, and at least one report condition for the corresponding candidate SCell; after a failure is detected on a serving SCell, receiving, from the UE via the SpCell, report information comprising information for a candidate SCell based on a report condition for the candidate SCell being satisfied, wherein the candidate SCell is among at least one candidate SCell identified as being associated with the serving SCell based on the association information; and transmitting, to the UE via the SpCell, a switching command to the candidate SCell after receiving the report information.

According to an embodiment of the present disclosure, a method performed by a network node configured to operate in a wireless communication system comprises: transmitting, to a user equipment (UE) via a special cell (SpCell), a configuration for one or more candidate secondary cells (SCells), wherein the configuration comprises association information informing one or more SCells associated with a corresponding candidate SCell, and at least one report condition for the corresponding candidate SCell; after a failure is detected on a serving SCell, receiving, from the UE via the SpCell, report information comprising information for a candidate SCell based on a report condition for the candidate SCell being satisfied, wherein the candidate SCell is among at least one candidate SCell identified as being associated with the serving SCell based on the association information; and transmitting, to the UE via the SpCell, a switching command to the candidate SCell after receiving the report information.

According to an embodiment of the present disclosure, an apparatus adapted to operate in a wireless communication system comprises: at least processor; and at least one memory operatively coupled to the at least one processor and storing instructions that, based on being executed by the at least one processor, perform operations comprising: receiving, from a network via a special cell (SpCell), a configuration for one or more candidate secondary cells (SCells), wherein the configuration comprises association information informing one or more SCells associated with a corresponding candidate SCell, and at least one report condition for the corresponding candidate SCell; detecting a failure on a serving SCell; after detecting the failure on the serving SCell, identifying at least one candidate SCell associated with the serving SCell based on the association information; based on a report condition for a candidate SCell among the at least one candidate SCell being satisfied, transmitting report information comprising information for the candidate SCell to the network via the SpCell; receiving, from the network via the SpCell, a switching command to the candidate SCell after transmitting the report information; and applying a configuration for the candidate SCell based on the switching command.

According to an embodiment of the present disclosure, a non-transitory computer readable medium (CRM) has stored thereon a program code implementing instructions that, based on being executed by at least one processor, perform operations comprising: receiving, from a network via a special cell (SpCell), a configuration for one or more candidate secondary cells (SCells), wherein the configuration comprises association information informing one or more SCells associated with a corresponding candidate SCell, and at least one report condition for the corresponding candidate SCell; detecting a failure on a serving SCell; after detecting the failure on the serving SCell, identifying at least one candidate SCell associated with the serving SCell based on the association information; based on a report condition for a candidate SCell among the at least one candidate SCell being satisfied, transmitting report information comprising information for the candidate SCell to the network via the SpCell; receiving, from the network via the SpCell, a switching command to the candidate SCell after transmitting the report information; and applying a configuration for the candidate SCell based on the switching command.

The present disclosure may have various advantageous effects.

For example, when the SCell is not available due to any (link) problem, the UE can request a fast SCell switching to the network based on the association between the current SCell and candidate cells. Through this request, pending data transmission can be reduced by the fast SCell switching requested by the UE.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF DRAWINGS

FIG. 1 shows an example of a communication system to which implementations of the present disclosure is applied.

FIG. 2 shows an example of wireless devices to which implementations of the present disclosure is applied.

FIG. 3 shows an example of UE to which implementations of the present disclosure is applied.

FIGS. 4 and 5 show an example of protocol stacks in a 3GPP based wireless communication system to which implementations of the present disclosure is applied.

FIG. 6 shows a frame structure in a 3GPP based wireless communication system to which implementations of the present disclosure is applied.

FIG. 7 shows a data flow example in the 3GPP NR system to which implementations of the present disclosure is applied.

FIG. 8 shows an example of a procedure for a normal measurement according to an embodiment of the present disclosure.

FIG. 9 shows an example of a legacy handover procedure to which technical features of the present disclosure can be applied.

FIG. 10 shows an example of a conditional handover procedure to which technical features of the present disclosure can be applied.

FIG. 11 shows an example of a signal flow for detecting SCell problem according to an embodiment of the present disclosure.

FIG. 12 shows an example of a method performed by a UE according to an embodiment of the present disclosure.

FIG. 13 shows an example of a signal flow between a UE and a network node according to an embodiment of the present disclosure.

FIG. 14 shows an example of a method for SCell switching according to an embodiment of the present disclosure.

FIG. 15 shows a signal flow for SCell switching according to an embodiment of the present disclosure.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in downlink (DL) and SC-FDMA in uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

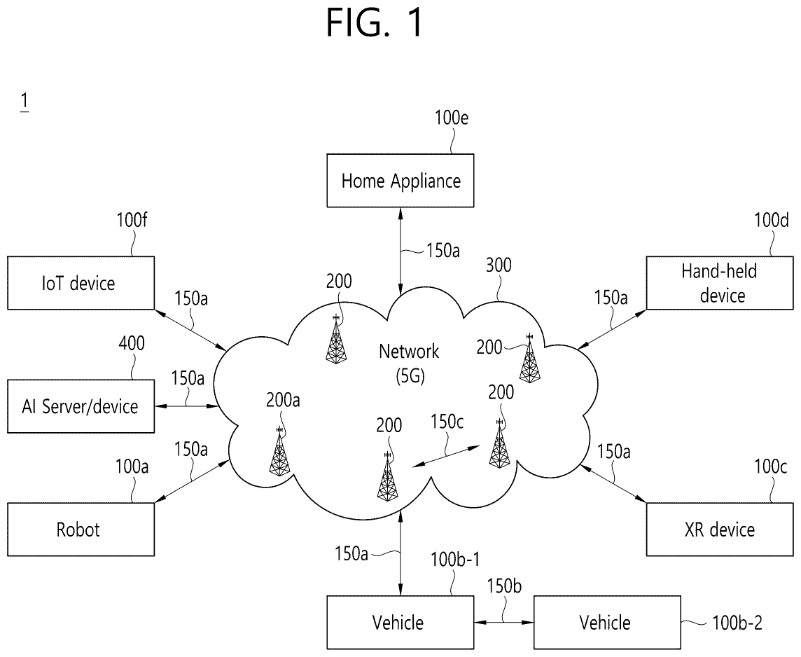

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an extended Reality (XR) device 100c, a hand-held device 100d, a home appliance 100e, an Internet-of-Things (IOT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding | Subcarrier |
|---|---|---|
| designation | frequency range | Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

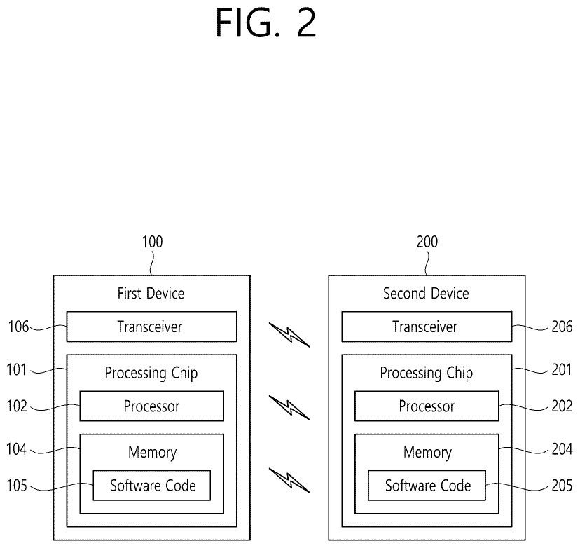

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names. FIG. 2 shows an example of wireless devices to which implementations of the present disclosure is applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104 and 204 may be connected to the one or more processors 102 and 202 and store various types of data, signals, messages, information, programs, code, instructions, and/or commands. The one or more memories 104 and 204 may be configured by Random Access Memory (RAM), Dynamic RAM (DRAM), Read-Only Memory (ROM), electrically Erasable Programmable Read-Only Memory (EPROM), flash memory, volatile memory, non-volatile memory, hard drive, register, cash memory, computer-readable storage medium, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208. Additionally and/or alternatively, the one or more transceivers 106 and 206 may include one or more antennas 108 and 208. The one or more transceivers 106 and 206 may be adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in Uplink (UL) and as a receiving device in Downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

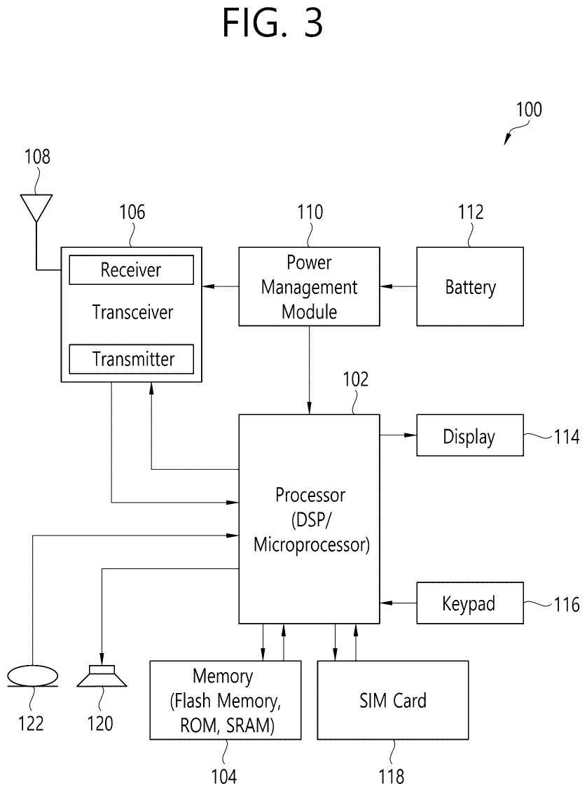

FIG. 3 shows an example of UE to which implementations of the present disclosure is applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor.

The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

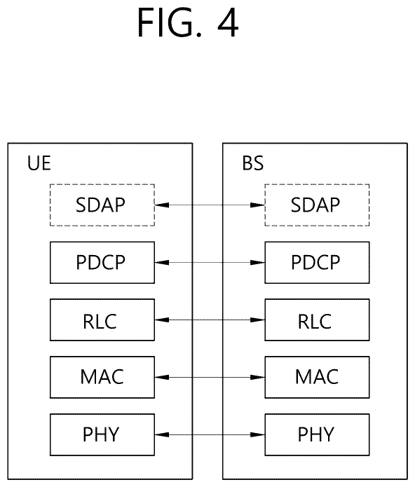

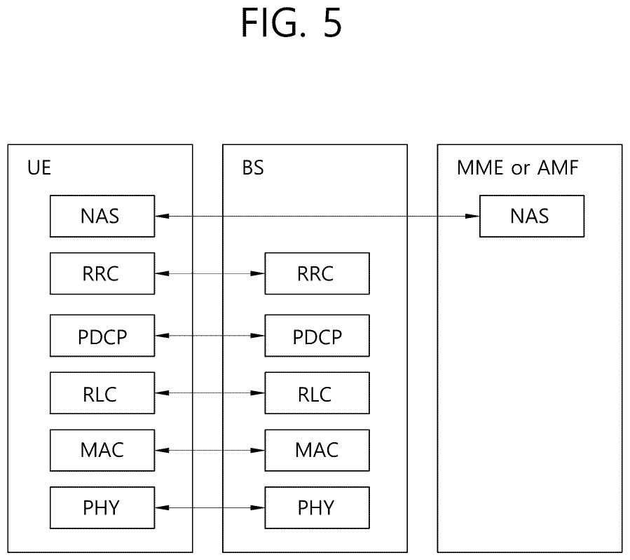

FIGS. 4 and 5 show an example of protocol stacks in a 3GPP based wireless communication system to which implementations of the present disclosure is applied.

In particular, FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (i.e., a PHY layer) and Layer 2. Referring to FIG. 5, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

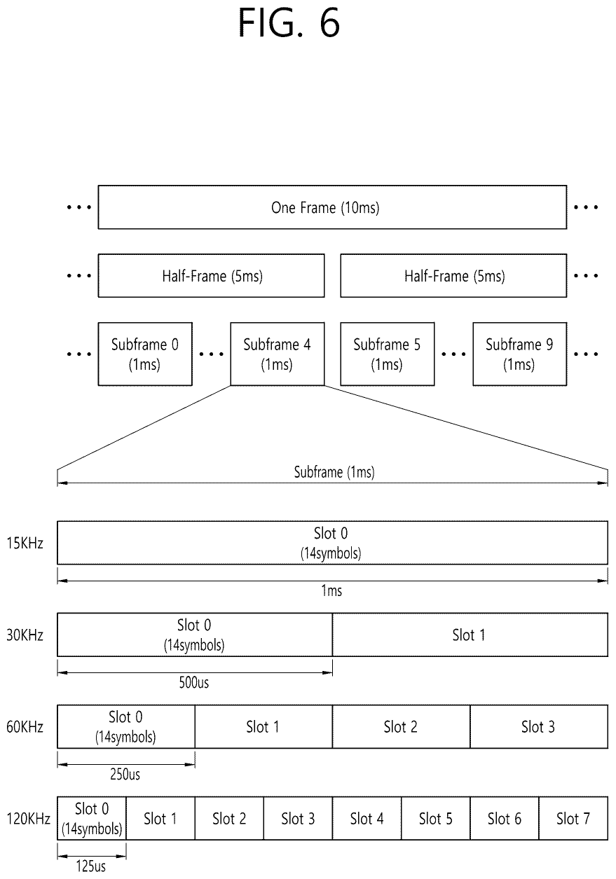

FIG. 6 shows a frame structure in a 3GPP based wireless communication system to which implementations of the present disclosure is applied.

The frame structure shown in FIG. 6 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 6, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is Ims. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing βf=2^{u}*15 kHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing βf=2^{u}*15 kHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing βf=2^{u}*15 kHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index/representing a symbol location relative to a reference point in the time domain. In the 3GPP based wireless communication system, an RB is defined by 12 consecutive subcarriers in the frequency domain. As shown in FIG. 6, as SCS doubles, the slot length and symbol length are halved. For example, when SCS is 15 kHz, the slot length is Ims, which is the same as the subframe length. When SCS is 30 kHz, the slot length is 0.5 ms (=500 us), and the symbol length is half of that when the SCS is 15 kHz. When SCS is 60 kHz, the slot length is 0.25 ms (=250 us), and the symbol length is half of that when the SCS is 30 kHz. When SCS is 120 kHz, the slot length is 0.125 ms (=125 us), and the symbol length is half of that when the SCS is 60 kHz. When SCS is 240 kHz, the slot length is 0.0625 ms (=62.5 us), and the symbol length is half of that when the SCS is 120 KHz.

In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{Size}_{BWP,i}, where N^{Size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

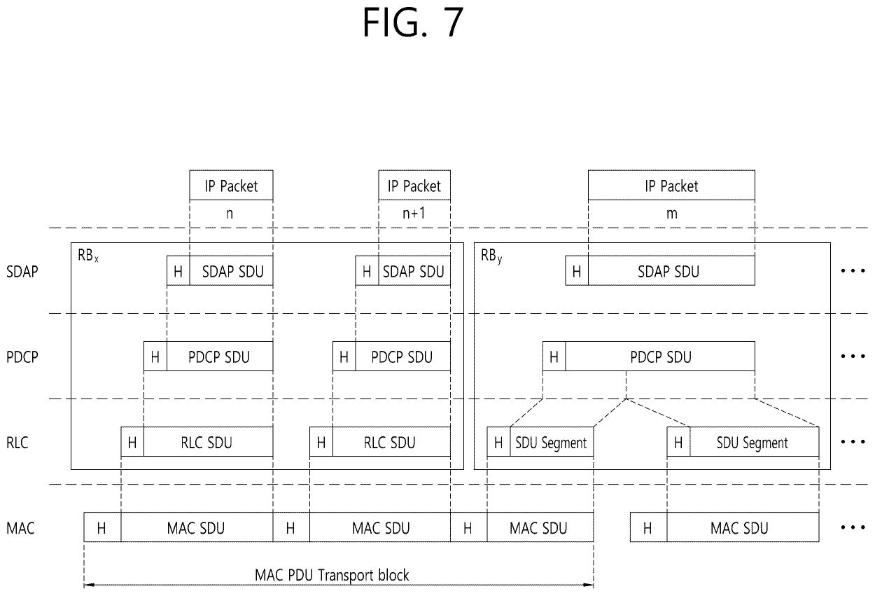

FIG. 7 shows a data flow example in the 3GPP NR system to which implementations of the present disclosure is applied.

Referring to FIG. 7, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels physical uplink shared channel (PUSCH) and physical random access channel (PRACH), respectively, and the downlink transport channels DL-SCH, BCH and PCH are mapped to physical downlink shared channel (PDSCH), physical broadcast channel (PBCH) and PDSCH, respectively. In the PHY layer, uplink control information (UCI) is mapped to physical uplink control channel (PUCCH), and downlink control information (DCI) is mapped to physical downlink control channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

Hereinafter, radio link failure related actions are described.

The UE shall:
1> if any DAPS bearer is configured, upon receiving N310 consecutive “out-of-sync” indications for the source SpCell from lower layers and T304 is running:
2> consider physical layer problems are detected in RRC_CONNECTED, and/or start timer T310 for the source SpCell.
1> upon receiving N310 consecutive “out-of-sync” indications for the SpCell from lower layers while neither T300, T301, T304, T311, T316 nor T319 are running:
2> consider physical layer problems are detected in RRC_CONNECTED, and/or start timer T310 for the corresponding SpCell.

Upon receiving N311 consecutive “in-sync” indications for the SpCell from lower layers while T310 is running, the UE shall:
1> consider the physical layer problems are recovered, and/or stop timer T310 for the corresponding SpCell.
1> consider the physical layer problems are recovered, and/or stop timer T312 for the corresponding SpCell, if running.

In this case, the UE maintains the RRC connection without explicit signalling, i.e. the UE maintains the entire radio resource configuration.

Periods in time where neither “in-sync” nor “out-of-sync” is reported by L1 do not affect the evaluation of the number of consecutive “in-sync” or “out-of-sync” indications.

The UE shall:
1> If any DAPS bearer is configured and T304 is running:
2> upon T310 expiry in source SpCell; or
2> upon random access problem indication from source MCG MAC; or
2> upon indication from source MCG RLC that the maximum number of retransmissions has been reached; or
2> upon consistent uplink LBT failure indication from source MCG MAC:
3> consider radio link failure to be detected for the source MCG i.e. source RLF;
3> suspend the transmission and reception of all DRBs and multicast MRBs in the source MCG;
3> reset MAC for the source MCG;
3> release the source connection.
1> else:
2> during a DAPS handover: the following only applies for the target PCell;
2> upon T310 expiry in PCell; or
2> upon T312 expiry in PCell; or
2> upon random access problem indication from MCG MAC while neither T300, T301, T304, T311 nor T319 are running; or
2> upon indication from MCG RLC that the maximum number of retransmissions has been reached; or
2> if connected as an IAB-node, upon BH RLF indication received on BAP entity from the MCG; or
2> upon consistent uplink LBT failure indication from MCG MAC while T304 is not running:
3> if the indication is from MCG RLC and CA duplication is configured and activated for MCG, and for the corresponding logical channel allowedServingCells only includes SCell(s):
4> initiate the failure information procedure to report RLC failure.
3> else:
4> consider radio link failure to be detected for the MCG, i.e. MCG RLF;
4> discard any segments of segmented RRC messages;
4> if AS security has not been activated:
5> perform the actions upon going to RRC_IDLE, with release cause ‘other’;—
4> else if AS security has been activated but SRB2 and at least one DRB or multicast MRB or, for IAB, SRB2, have not been setup:
5> store the radio link failure information in the VarRLF-Report;
5> perform the actions upon going to RRC_IDLE, with release cause ‘RRC connection failure’;
4> else:
5> store the radio link failure information in the VarRLF-Report;
5> if T316 is configured; and
5> if SCG transmission is not suspended; and
5> if the SCG is not deactivated; and
5> if neither PSCell change nor PSCell addition is ongoing (i.e. timer T304 for the NR PSCell is not running in case of NR-DC or timer T307 of the E-UTRA PSCell is not running, in NE-DC):
6> initiate the MCG failure information procedure to report MCG radio link failure.
5> else:
6> initiate the connection re-establishment procedure.

The UE shall:
1> upon T310 expiry in PSCell; or
1> upon T312 expiry in PSCell; or
1> upon random access problem indication from SCG MAC; or
1> upon indication from SCG RLC that the maximum number of retransmissions has been reached; or
1> if connected as an IAB-node, upon BH RLF indication received on BAP entity from the SCG; or
1> upon consistent uplink LBT failure indication from SCG MAC:
2> if the indication is from SCG RLC and CA duplication is configured and activated for SCG, and for the corresponding logical channel allowedServingCells only includes SCell(s):
3> initiate the failure information procedure as specified in 5.7.5 to report RLC failure.
2> else:
3> consider radio link failure to be detected for the SCG, i.e. SCG RLF;
3> if MCG transmission is not suspended:
4> initiate the SCG failure information procedure to report SCG radio link failure.
3> else:
4> if the UE is in NR-DC:
5> initiate the connection re-establishment procedure;
4> else (the UE is in (NG) EN-DC):
5> initiate the connection re-establishment procedure;
Hereinafter, beam failure detection is described.

The MAC entity may be configured by RRC per Serving Cell with a beam failure recovery procedure which is used for indicating to the serving gNB of a new SSB or CSI-RS when beam failure is detected on the serving SSB(s)/CSI-RS(s). Beam failure is detected by counting beam failure instance indication from the lower layers to the MAC entity. If beamFailureRecoveryConfig is reconfigured by upper layers during an ongoing Random Access procedure for beam failure recovery for SpCell, the MAC entity shall stop the ongoing Random Access procedure and initiate a Random Access procedure using the new configuration.

The UE variable “BFI_COUNTER” is used for the beam failure detection procedure. The BFI_COUNTER is a counter for beam failure instance indication which is initially set to 0, per Serving Cell or per BFD-RS set of Serving Cell configured with two BFD-RS sets.

The MAC entity shall for each Serving Cell configured for beam failure detection:
1> if the Serving Cell is configured with two BFD-RS sets, the MAC entity shall for each BFD-RS set of the Serving Cell:
2> if beam failure instance indication for a BFD-RS set has been received from lower layers:
3> start or restart the beamFailureDetectionTimer;
3> increment BFI_COUNTER of the BFD-RS set by 1;
3> if BFI_COUNTER>=beamFailureInstanceMaxCount:
4> trigger a BFR for this BFD-RS set of the Serving Cell;
2> if BFR is triggered for both BFD-RS sets of the SpCell and is not successfully completed:
3> initiate a Random Access procedure on the SpCell;
2> if the Serving Cell is SpCell and the Random Access procedure initiated for beam failure recovery of both BFD-RS sets of SpCell is successfully completed:
3> set BFI_COUNTER of each BFD-RS set of SpCell to 0.
3> consider the Beam Failure Recovery procedure successfully completed.
2> if the beamFailureDetectionTimer of this BFD-RS set expires; or
2> if beamFailureDetectionTimer, beamFailureInstanceMaxCount, or any of the reference signals used for beam failure detection is reconfigured by upper layers associated with this BFD-RS set of the Serving Cell:
3> set BFI_COUNTER of the BFD-RS set to 0.
2> if a PDCCH addressed to C-RNTI indicating uplink grant for a new transmission is received for the HARQ process used for the transmission of the Enhanced BFR MAC CE or Truncated Enhanced BFR MAC CE which contains beam failure recovery information of this BFD-RS set of the Serving Cell:
3> set BFI_COUNTER of the BFD-RS set to 0;
3> consider the Beam Failure Recovery procedure successfully completed and cancel all the triggered BFRs of this BFD-RS set of the Serving Cell.
2> if the Serving Cell is SCell and the SCell is deactivated:
3> set BFI_COUNTER of each BFD-RS set of SCell to 0;
3> consider the Beam Failure Recovery procedure successfully completed and cancel all the triggered BFRs of all BFD-RS sets of the Serving Cell.
1> else:
2> if beam failure instance indication has been received from lower layers:
3> start or restart the beamFailureDetectionTimer;
3> increment BFI_COUNTER by 1;
3> if BFI_COUNTER>=beamFailureInstanceMaxCount:
4> if the Serving Cell is SCell:
5> trigger a BFR for this Serving Cell;
4> else if the Serving Cell is PSCell, the SCG is deactivated and beam failure of the PSCell was not indicated to upper layers since the SCG was deactivated:
5> indicate beam failure of the PSCell to upper layers.
4> else
5> initiate a Random Access procedure on the SpCell.
2> if the beamFailureDetectionTimer expires; or
2> if beamFailureDetectionTimer, beamFailureInstanceMaxCount, or any of the reference signals used for beam failure detection is reconfigured by upper layers associated with this Serving Cell:
3> set BFI_COUNTER to 0.
2> if the Serving Cell is SpCell and the Random Access procedure initiated for SpCell beam failure recovery is successfully completed:
3> set BFI_COUNTER to 0;
3> stop the beamFailureRecoveryTimer, if configured;
3> consider the Beam Failure Recovery procedure successfully completed.
2> else if the Serving Cell is SCell, and a PDCCH addressed to C-RNTI indicating uplink grant for a new transmission is received for the HARQ process used for the transmission of the BFR MAC CE or Truncated BFR MAC CE which contains beam failure recovery information of this Serving Cell; or
2> if the SCell is deactivated:
3> set BFI_COUNTER to 0;
3> consider the Beam Failure Recovery procedure successfully completed and cancel all the triggered BFRs for this Serving Cell.

The MAC entity shall:
1> if the Beam Failure Recovery procedure determines that at least one BFR has been triggered and not cancelled for an SCell for which evaluation of the candidate beams according to the requirements has been completed and if none of the Serving Cell(s) of this MAC entity are configured with two BFD-RS sets:
2> if UL-SCH resources are available for a new transmission and if the UL-SCH resources can accommodate the BFR MAC CE plus its subheader as a result of LCP:
3> instruct the Multiplexing and Assembly procedure to generate the BFR MAC CE.
2> else if UL-SCH resources are available for a new transmission and if the UL-SCH resources can accommodate the Truncated BFR MAC CE plus its subheader as a result of LCP:
3> instruct the Multiplexing and Assembly procedure to generate the Truncated BFR MAC CE.
2> else:
3> trigger the SR for SCell beam failure recovery for each SCell for which BFR has been triggered, not cancelled, and for which evaluation of the candidate beams according to the requirements has been completed.
1> if the Beam Failure Recovery procedure determines that at least one BFR for BFD-RS set has been triggered and not cancelled for an SCell for which evaluation of the candidate beams according to the requirements has been completed; or
1> if the Beam Failure Recovery procedure determines that at least one BFR for BFD-RS set for only one BFD-RS set has been triggered and not cancelled for an SpCell for which evaluation of the candidate beams has been completed; or
1> if the Beam Failure Recovery procedure determines that at least one BFR has been triggered and not cancelled for an SCell for which evaluation of the candidate beams according to the requirements has been completed and if at least one Serving Cell of this MAC entity is configured with two BFD-RS sets:
2> if UL-SCH resources are available for a new transmission and if the UL-SCH resources can accommodate the Enhanced BFR MAC CE plus its subheader as a result of LCP:
3> instruct the Multiplexing and Assembly procedure to generate the Enhanced BFR MAC CE.
2> else if UL-SCH resources are available for a new transmission and if the UL-SCH resources can accommodate the Truncated Enhanced BFR MAC CE plus its subheader as a result of LCP:
3> instruct the Multiplexing and Assembly procedure to generate the Truncated Enhanced BFR MAC CE.
2> else:
3> trigger the SR for beam failure recovery of each BFD-RS set for which BFR has been triggered, not cancelled, and for which evaluation of the candidate beams according to the requirements has been completed;
3> trigger the SR for SCell beam failure recovery for each SCell for which BFR has been triggered, not cancelled, and for which evaluation of the candidate beams according to the requirements has been completed.

All BFRs triggered for an SCell shall be cancelled when a MAC PDU is transmitted and this PDU includes a BFR MAC CE or Truncated BFR MAC CE which contains beam failure information of that SCell. All BFRs triggered for a BFD-RS set of a Serving Cell shall be cancelled when a MAC PDU is transmitted and this PDU includes an Enhanced BFR MAC CE or Truncated Enhanced BFR MAC CE which contains beam failure recovery information of that BFD-RS set of the Serving Cell.

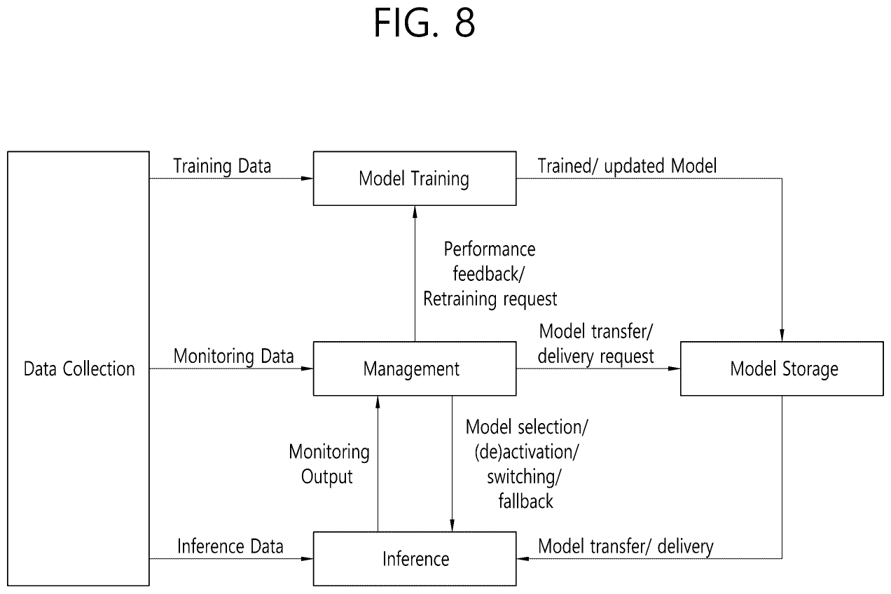

FIG. 8 shows an example of a procedure for a normal measurement according to an embodiment of the present disclosure.

Referring to FIG. 8, in step S801, the UE may receive, from a network, a measurement configuration. The measurement configuration may comprise a list of measurement objects (measObject), a list of report configurations (reportConfig), and a list of measurement identifiers ID, measID). The measurement ID may be related to/correspond to a combination of a measurement object and a report configuration. The measurement object may indicate object information regarding an object the UE is supposed to measure. For example, the object information may comprise a measurement frequency and/or a list of cells including serving cell/neighbor cell(s). The report configuration may comprise a condition to perform an action corresponding to a report type in the report configuration. For example, the condition may comprise a report condition that should be satisfied for the UE to transmit a measurement report.

In step S803, the UE may perform a measurement based on the measurement configuration. For example, the UE may measure reference signals received from the serving cell and/or the neighbor cell(s) on the measurement frequency specified by the measurement object, to obtain a measurement result for the serving cell and/or the neighbor cell(s). The measurement result may comprise a cell quality/signal strength/signal quality/channel quality/channel state/reference signal received power (RSRP)/reference signal received quality (RSRQ) of the serving cell and/or the neighbor cell(s). The UE may perform an actual measurement of the reference signals, and derive a measurement result based on the actual measurement possibly with post-processing of the measurement results of the reference signals (e.g., filtering based on linear average or exponential moving average or etc.).

In step S805, the UE may transmit a measurement report to the network. The UE may transmit the measurement report comprising the measurement result for the serving cell and/or the neighbor cell(s) to the network based on the report configuration (e.g., when the report condition is satisfied).

Hereinafter, contents regarding handover (HO) are described.

The handover may comprise PCell change. Further, in the present disclosure, descriptions related to handover may also be applied to other mobility procedures, such as PSCell change (or, secondary node (SN) change) and/or PSCell addition (or, SN addition).

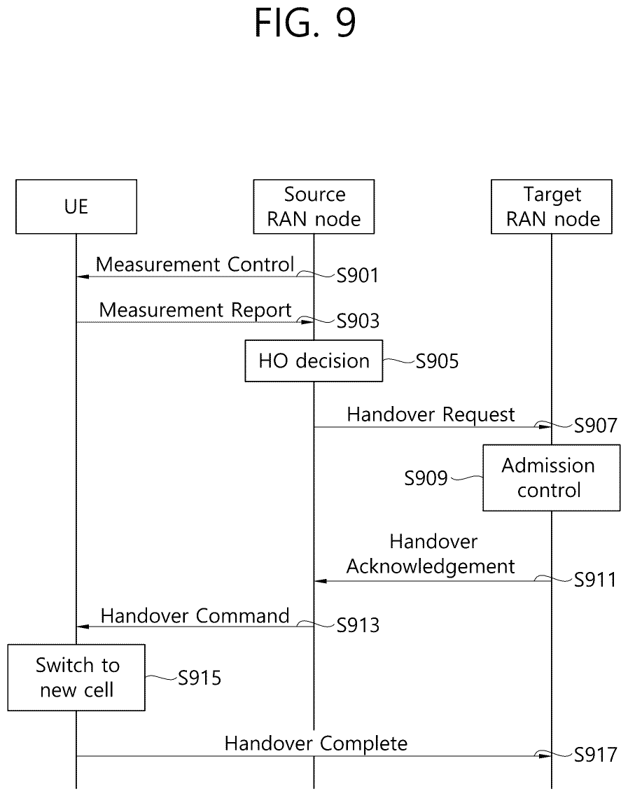

FIG. 9 shows an example of a legacy handover procedure to which technical features of the present disclosure can be applied.

Referring to FIG. 9, in step S901, the source RAN node may transmit measurement control message to the UE. The source RAN node may configure the UE measurement procedures according to the roaming and access restriction information and, for example, the available multiple frequency band information through the measurement control message. Measurement control information provided by the source RAN node through the measurement control message may assist the function controlling the UE's connection mobility. For example, the measurement control message may comprise measurement configuration and/or report configuration.

In step S903, the UE may transmit a measurement report message to the source RAN node. The measurement report message may comprise a result of measurement on neighbor cell(s) around the UE which can be detected by the UE. The UE may generate the measurement report message according to a measurement configuration and/or measurement control information in the measurement control message received in step S901.

In step S905, the source RAN node may make a handover (HO) decision based on the measurement report. For example, the source RAN node may make a HO decision and determine a target RAN node for HO among neighbor cells around the UE based on a result of measurement (e.g., cell quality, signal quality, signal strength, reference signal received power (RSRP), reference signal received quality (RSRP), channel state, channel quality, signal to interference plus noise ratio (SINR)) on the neighbor cells.

In step S907, the source RAN node may transmit a HO request message to the target RAN node which is determined in step S905. That is, the source RAN node may perform handover preparation with the target RAN node. The HO request message may comprise necessary information to prepare the handover at the target RAN node.

In step S909, the target RAN node may perform an admission control based on information included in the HO request message. The target RAN node may configure and reserve the required resources (e.g., C-RNTI and/or RACH preamble). The AS-configuration to be used in the target RAN node can either be specified independently (i.e. an “establishment”) or as a delta compared to the AS-configuration used in the source RAN node (i.e. a “reconfiguration”).

In step S911, the target RAN node may transmit a HO request acknowledge (ACK) message to the source RAN node. The HO request ACK message may comprise information on resources reserved and prepared for a handover. For example, the HO request ACK message may comprise a transparent container to be sent to the UE as an RRC message to perform the handover. The container may include a new C-RNTI, target gNB security algorithm identifiers for the selected security algorithms, a dedicated RACH preamble, and/or possibly some other parameters i.e. access parameters, SIBs. If RACH-less handover is configured, the container may include timing adjustment indication and optionally a preallocated uplink grant. The HO request ACK message may also include RNL/TNL information for forwarding tunnels, if necessary. As soon as the source RAN node receives the HO request ACK message, or as soon as the transmission of the handover command is initiated in the downlink, data forwarding may be initiated.

In step S913, the source RAN node may transmit a handover command, to the UE. For example, the handover command may comprise or may be a cell configuration (i.e., RRCReconfiguration message including the reconfigurationWithSync). The RRCReconfiguration message and/or reconfigurationWithSync for a target cell may comprise information required to access the target cell (i.e., access configuration) comprising at least one of a physical cell ID of the target cell, identifier of the UE (i.e., C-RNTI), HO validity timer (i.e., T304 timer), the target gNB security algorithm identifiers for the selected security algorithms, a set of dedicated RACH resources for contention-free random access (e.g., dedicated random access preamble), the association between RACH resources and SSB(s), the association between RACH resources and UE-specific CSI-RS configuration(s), common RACH resources, or system information of the target cell. The source RAN node may perform the necessary integrity protection and ciphering of the message.

In step S915, the UE may switch to a new cell i.e., the target RAN node. The UE may detach from the old cell i.e., the source RAN node and synchronize to a new cell i.e., the target RAN node. The UE may perform a handover from the source RAN node to the target RAN node based on applying the cell configuration. For example, upon receiving the handover command, the UE may start the T304 timer, and perform a contention-free random access towards the target RAN node based on the set of dedicated RACH resources.

In step S917, upon successful completion of the random access procedure, the UE may stop the T304 timer, and transmit a handover complete message (i.e., RRCReconfigurationComplete message) to the target RAN node. The UE may send the RRCReconfigurationComplete message comprising the C-RNTI to confirm the handover, to the target RAN node to indicate that the handover procedure is completed for the UE. The target RAN node may verify the C-RNTI sent in the RRCReconfigurationComplete message. The target RAN node can now begin sending data to the UE. When the random access fails and the T304 timer is still running, the UE may retry random access towards the target RAN node. Upon expiry of the T304 timer, the UE may declare handover failure (HOF) and perform an RRC re-establishment procedure.

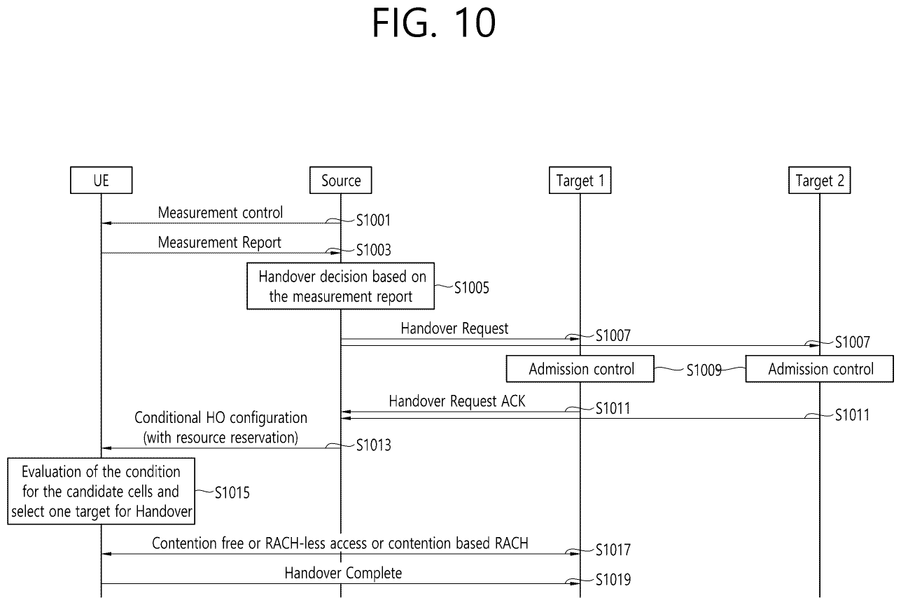

FIG. 10 shows an example of a conditional handover procedure to which technical features of the present disclosure can be applied.

Referring to FIG. 10, in step S1001, the source cell may transmit measurement control message to the UE. The measurement control message may comprise a measurement configuration including a list of measurement configurations, and each measurement configuration in the list includes a measurement identity (ID), the corresponding measurement object and the corresponding report configuration.

In step S1003, the UE may transmit a measurement report message to the source cell. The measurement report message may comprise a result of measurement on neighbor cell(s) around the UE which can be detected by the UE. The UE may generate the measurement report message according to a measurement configuration and/or measurement control information in the measurement control message received in step S1001.

In step S1005, the source cell may make a handover decision based on the measurement report. For example, the source cell may make a handover decision and determine candidate target cells (e.g., target cell 1 and target cell 2) for handover among neighbor cells around the UE based on a result of measurement (e.g., signal quality, reference signal received power (RSRP), reference signal received quality (RSRP)) on the neighbor cells.

In step S1007, the source cell may transmit handover request messages to the target cell 1 and the target cell 2 which are determined in step S1005. That is, the source cell may perform handover preparation with the target cell 1 and the target cell 2. The handover request message may comprise necessary information to prepare the handover at the target side (e.g., target cell 1 and target cell 2).

In step S1009, each of the target cell 1 and the target cell 2 may perform an admission control based on information included in the handover request message. The target cell may configure and reserve the required resources (e.g., C-RNTI and/or RACH preamble). The AS-configuration to be used in the target cell can either be specified independently (i.e. an “establishment”) or as a delta compared to the AS-configuration used in the source cell (i.e. a “reconfiguration”).

In step S1011, the target cell and the target cell 2 may transmit a handover request acknowledge (ACK) message to the source cell. The handover request ACK message may comprise cell configuration (i.e., RRCReconfiguration message including ReconfigurationWithSync) including information on resources reserved and prepared for a handover. For example, the handover request ACK message may comprise a transparent container to be sent to the UE as an RRC message (i.e., RRCReconfiguration message/cell configuration) to perform the handover. The container/cell configuration/RRCReconfiguration message may include information required to access the target cell (i.e., access configuration) comprising at least one of a physical cell ID of the target cell, identifier of the UE (i.e., C-RNTI), HO validity timer (i.e., T304 timer), the target gNB security algorithm identifiers for the selected security algorithms, a set of dedicated RACH resources for contention-free random access (e.g., dedicated random access preamble), the association between RACH resources and SSB(s), the association between RACH resources and UE-specific CSI-RS configuration(s), common RACH resources, or system information of the target cell. If RACH-less handover is configured, the container may include timing adjustment indication and optionally a pre-allocated uplink grant. The handover request ACK message may also include RNL/TNL information for forwarding tunnels, if necessary. As soon as the source cell receives the handover request ACK message, or as soon as the transmission of the conditional handover command is initiated in the downlink, data forwarding may be initiated.

In step S1013, the source cell may transmit a RRCReconfiguration message including a conditional reconfiguration to the UE. The conditional reconfiguration may be also referred to as (or, may comprise) conditional handover (CHO) configuration and/or a conditional handover command (e.g., CHO command). The conditional reconfiguration may comprise a list of conditional reconfigurations/conditional handover commands, including a conditional reconfiguration/conditional handover command for each of the candidate target cells (e.g., target cell 1, target cell 2). For example, the conditional reconfiguration may comprise a conditional reconfiguration/conditional handover command for the target cell 1, and a conditional reconfiguration/conditional handover command for the target cell 2. The conditional reconfiguration for a target cell may comprise an index/identifier identifying the corresponding conditional reconfiguration, a handover condition for the target cell, and/or a cell configuration (i.e., RRCReconfiguration message including the reconfigurationWithSync) for the target cell. The RRCReconfiguration message and/or reconfigurationWithSync for the target cell may comprise information required to access the target cell comprising at least one of a physical cell ID of the target cell, identifier of the UE (i.e., C-RNTI), HO validity timer (i.e., T304 timer), the target gNB security algorithm identifiers for the selected security algorithms, a set of dedicated RACH resources for contention-free random access (e.g., dedicated random access preamble), the association between RACH resources and SSB(s), the association between RACH resources and UE-specific CSI-RS configuration(s), common RACH resources, or system information of the target cell.

In step S1015, the UE may perform an evaluation of the handover condition for the candidate target cells (e.g., target cell 1, target cell 2) and select a target cell for a handover among the candidate target cells. For example, the UE may perform measurements on the candidate target cells, and determine whether a candidate target cell fulfils a handover condition for the candidate target cell among the candidate target cells based on a result of the measurements on the candidate target cells. Or, the UE may determine whether the target cell/measurement result for the target cell fulfils the handover condition of the target cell. If the UE identifies that the target cell 1 fulfils a handover condition for the target cell 1, the UE may select the target cell 1 as a target cell for the handover.

In step S1017, the UE may detach from the old cell i.e., the source cell and synchronize to a new cell i.e., the selected target cell. The UE may perform a handover from the source cell to the target cell based on applying the cell configuration. For example, upon receiving the handover command, the UE may start the T304 timer, and perform a contention-free random access towards the target cell based on the set of dedicated RACH resources.

In step S1019, upon successful completion of the random access procedure, the UE may stop the T304 timer, and transmit a handover complete message (i.e., RRCReconfigurationComplete message) to the target cell. The UE may send the RRCReconfigurationComplete message comprising the C-RNTI to confirm the handover, to the target cell to indicate that the handover procedure is completed for the UE. The target RAN node may verify the C-RNTI sent in the RRCReconfigurationComplete message. The target RAN node can now begin sending data to the UE. When the random access fails and the T304 timer is still running, the UE may retry random access towards the target cell. Upon expiry of the T304 timer, the UE may declare handover failure (HOF) and perform an RRC re-establishment procedure.

Meanwhile, in case one or more SCells have a link problem such as bad signal quality except for beam failure on the SCells, the UE still doesn't transmit any request to the network to resolve the problem. As a consequence, a pending situation of data transmission on the SCell may remain until the network implicitly recognizes the problem such as the reception of measurement reporting.

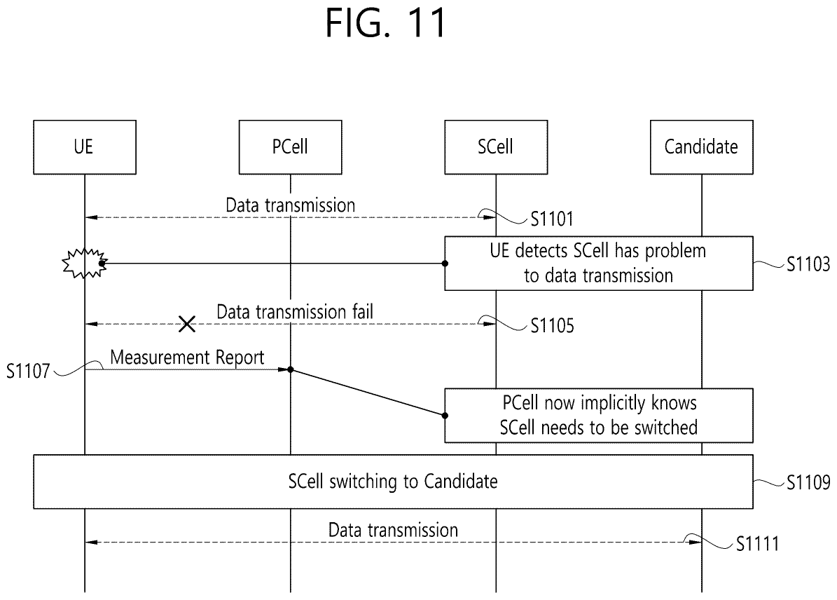

FIG. 11 shows an example of a signal flow for detecting SCell problem according to an embodiment of the present disclosure.

Referring to FIG. 11, in step S1101, UE may perform a data transmission with an SCell. UE may establish a connection with a PCell, receive a CA configuration comprising a configuration for the SCell, and activate the SCell based on the configuration for the SCell. UE may perform a data transmission with the PCell and/or the activated SCell for CA.

In step S1103, UE may detect that the SCell has a problem in data transmission.

In step S1105, data transmission between the UE and the SCell may fail.

In step S1107, UE may transmit a measurement report to the PCell. The measurement report may comprise information for a signal quality of the SCell. Based on the measurement report, PCell may implicitly know from the signal quality of the SCell that the SCell needs to be switched.

In step S1109, UE may perform a SCell switching from the SCell to a candidate SCell.

In step S1111, after the SCell switching, UE may perform a data transmission with the candidate SCell.

In wireless communications, a cell switching mechanism via lower-layer signaling is supported to minimize latency. In order for the UE to perform fast switching of PCell/PSCell/SCell via lower layer signaling, the network may provide in advance to the UE with a list of cell configurations for a plurality of candidate cells that can be applied to the fast switching.

The SCell problem as shown in FIG. 11 may be more quickly resolved than the time until the network implicitly recognizes the problem if the UE considers which candidate cells are associated with the current cell and explicitly indicates to the network via lower layer signaling which cells are helpful for fast SCell switching.

In the present disclosure, upon detection of a problem/failure on an SCell, UE may check a reporting condition for the SCell if there is a candidate cell associated with the SCell and the measurement result for the SCell satisfies a quality condition. If there exists a cell that satisfies the reporting condition, the UE may send a report to the network, e.g., via lower-layer signalling instead of initiating a recovery procedure to recovery from the problem/failure. The report may include the SCell identifier and the measurement results of the candidate cell associated with the SCell. If there exist multiple cells satisfying the reporting condition, the UE may send a report including the multiple candidate cells and the measurement results of the multiple candidate cells.

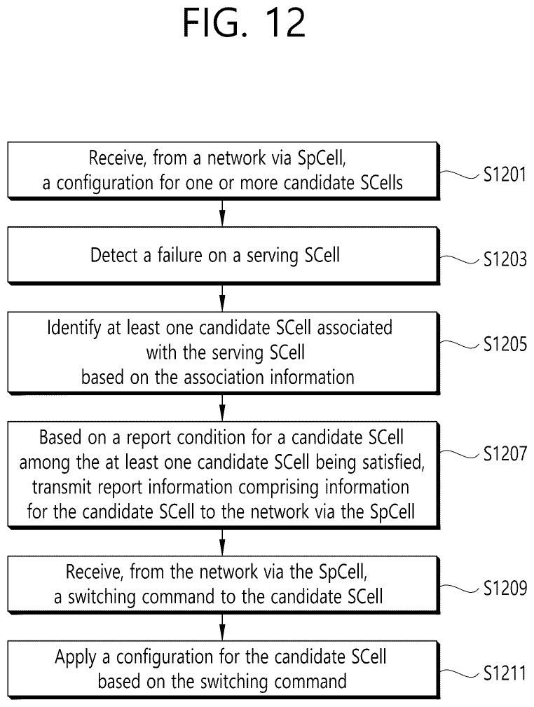

FIG. 12 shows an example of a method performed by a UE according to an embodiment of the present disclosure. The method may also be performed by a wireless device.

Referring to FIG. 12, in step S1201, UE may receive, from a network via an SpCell, a configuration for one or more candidate SCells. The configuration may comprise association information informing one or more SCells associated with a corresponding candidate SCell, and at least one report condition for the corresponding candidate SCell.

In step S1203, UE may detect a failure on a serving SCell.

In step S1205, after detecting the failure on the serving SCell, UE may identify at least one candidate SCell associated with the serving SCell based on the association information.

In step S1207, based on a report condition for a candidate SCell among the at least one candidate SCell being satisfied, UE may transmit report information comprising information for the candidate SCell to the network via the SpCell.

In step S1209, UE may receive, from the network via the SpCell, a switching command to the candidate SCell after transmitting the report information.

In step S1211, UE may apply a configuration for the candidate SCell based on the switching command.

According to various embodiments, the at least one candidate SCell associated with the serving SCell may be within at least one of: a same node as the serving SCell; a same cell group as the serving SCell; or a same timing advance group (TAG) as the serving SCell. The cell group may comprise at least one of a master cell group (MCG) or a secondary cell group (SCG).

According to various embodiments, the association information may comprise the at least one report condition.

According to various embodiments, the failure on the serving SCell may be detected based on a signal quality of the serving SCell being lower than a failure detection threshold. The failure detection threshold may comprise at least one of: a predetermined value; a UE-specific value signaled or configured by the network to the UE; or a cell-specific value broadcast by the network to the UE.

According to various embodiments, the failure on the serving SCell may be detected based on a number of beam failure instances detected for the serving SCell exceeding a beam failure detection threshold.

According to various embodiments, the failure on the serving SCell may be detected based on an expiry of a failure detection timer. The failure detection timer may start based on a number of states each in which a signal quality of the serving SCell is worse than a first threshold reaching a first threshold number. The failure detection timer may stop based on a number of states each in which a signal quality of the serving SCell is better than a second threshold reaching a second threshold number.

According to various embodiments, the information for the candidate SCell may comprise at least one of: an identifier (ID) of the candidate SCell; measurement results of the candidate SCell; or a timing advance (TA) status of the candidate SCell.

According to various embodiments, the report information further may comprise at least one of: an identifier (ID) of the serving SCell; or an indication that the failure is detected on the serving SCell.

According to various embodiments, the report information may be transmitted to the network via a media access control (MAC) control element (CE) signalling.

According to various embodiments, UE may obtain measurement results for the at least one candidate SCell based on measurements on the at least one candidate SCell. UE may perform an evaluation of a report condition for the at least one candidate SCell based on the measurement results for the at least one candidate SCell. The evaluation may comprise determining whether the report condition for the at least one candidate SCell is satisfied. The report condition for the at least one candidate SCell is satisfied based on the measurement results for the at least one candidate SCell satisfying a corresponding report condition.

According to various embodiments, UE may determine a report condition for one or more candidate SCells other than the candidate SCell being satisfied based on the evaluation. The report information may further comprise information for the one or more candidate SCells.

According to various embodiments, the applying of the configuration for the candidate SCell may comprise performing a switching to the candidate SCell from the serving SCell based on the switching command.

According to various embodiments, UE may receive configuration on one or more candidate cells including association between one or more serving cells and one or more candidate cells. The association may include measurement configuration and at least one report condition for each candidate cells. UE may detect a failure on a serving cell while performing measurement on candidate cells based on the measurement configuration. UE may check whether there is at least one candidate cell has association with the failed serving cell satisfied the report condition based on the measurement results. UE may report the candidate cell and/or the measurement results of the candidate cells when the report condition is satisfied.

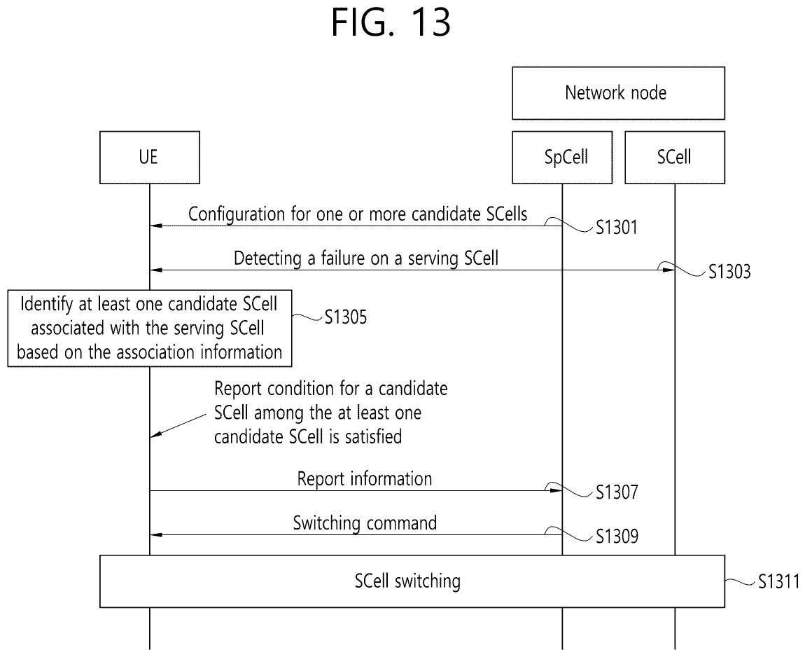

FIG. 13 shows an example of a signal flow between a UE and a network node according to an embodiment of the present disclosure. The network node may be related to an SpCell (i.e., PCell and/or PSCell), and may comprise a base station (BS).

Referring to FIG. 13, in step S1301, the network may transmit, to a UE via an SpCell, a configuration for one or more candidate secondary cells (SCells). The configuration may comprise association information informing one or more SCells associated with a corresponding candidate SCell, and at least one report condition for the corresponding candidate SCell;

In step S1303, UE may detect a failure on a serving SCell.

In step S1305, after detecting the failure on the serving SCell, UE may identify at least one candidate SCell associated with the serving SCell based on the association information.

In step S1307, the network node may receive, from the UE via the SpCell, report information comprising information for the candidate SCell, based on a report condition for a candidate SCell among the at least one candidate SCell being satisfied.

In step S1309, the network node may transmit, to the UE via the SpCell, a switching command to the candidate SCell after transmitting the report information.

In step S1311, the UE may apply a configuration for the candidate SCell based on the switching command.

In the present disclosure, UE may be configured with at least one SCell. The UE may receive a configuration to configure the UE with at least one candidate cell. The candidate cell is associated with at least one SCell. SCell can be associated with zero or more candidate cells. For a current SCell, one of the candidate cells associated with the SCell can become a new SCell by, e.g., the network command to trigger a cell switching from the current SCell to the one of the candidate cells associated with the SCell. The association may comprise candidate cells within the same node, i.e. intra-node or cell group which has the same timing advance (TA). The configuration may include one or more association information to indicate which candidate cell configuration is associated with which SCell for cell switching.

The configuration may also include one or more quality conditions for the report to request the cell switching. These conditions can be a type of threshold and each condition may correspond to each candidate cell. These conditions may be used only if the UE detects problems on SCells. If at least one condition is satisfied, the UE may report information to request the cell switching to the network. If the UE detects the problem on the SCell, these conditions may be used to report the information including candidate cells associated with the SCell, and satisfying the corresponding condition.

For the detection of problems on SCells, while performing measurements for SCells and candidate cells, the UE may determine that data transmission cannot be performed on the SCell when the signal quality of the SCell is lower than a specific threshold. This specific threshold may be a pre-defined value between the network and the UE and may be a dedicated value via RRC signaling or a common value via broadcast signalling, e.g., system information. The specific threshold value can be used to early report the problem of the SCell, i.e., if the signal quality of the SCell is below the specific threshold, the UE may not have the actual problem on data transmission. In the case of a pre-defined value, the same threshold as the value applied to detect the link failure on SpCell may be applied. As another condition to detect the problem on SCell, beam failure on SCell can be used. If the network indicates the beam failure on the SCell as the condition to detect the problem on SCell, the additional threshold may not be required, i.e., the UE may determine the problem on the SCell upon declaration of the beam failure on the SCell.

For the measurement for SCells and candidate cells, the UE may receive measurement configuration for SCell and candidate cells from the network. The measurement configuration can be provided before the association is provided, and can be provided together when the association is provided. If the network does not provide conditions for candidate cells when providing association information to the UE, the conditions may be provided in the measurement configuration.

For reporting to the network for the problem on the SCells, the UE may report the information via lower layer signaling or RRC signalling when at least one condition to report the problems on SCell is met. For lower-layer signaling, PHY DCI information or MAC CE can be used. This report can include information indicating which SCell has the problem and which candidate cells have associations that can be applicable for the next SCell like below:
1) SCell identity: serving cell index or physical cell ID (PCI) may be included for the SCell;
2) Candidate Cell identity: all cell identities for candidate cells that have the association with the SCell;
3) Measurement results: Among candidate cells that have the association with the SCell, only measurement results of the candidate cells that satisfied the condition to report are included. For the measurement results, RSRP, RSRQ, and SINR values may be used. Otherwise, to save the size of the reporting, only Boolean values for each candidate cell to inform whether the threshold has been exceeded and/or report condition is satisfied may be used. When reporting only with the Boolean value, the UE can report only candidate cell identities instead of the measurement results. In this case, all reported cell identities may mean the true values of candidate cells that satisfy the condition.
4) TA status: if the UE can check whether the TA status of the reported candidate cell is valid, the TA status can be also included. If the TA status is invalid, the UE may exclude the candidate cell from the reporting.

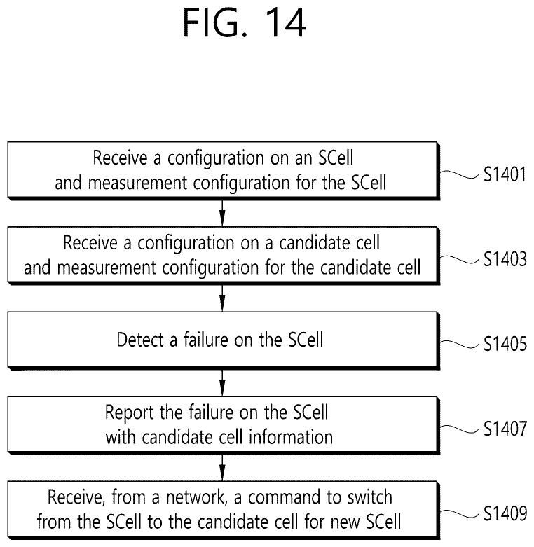

FIG. 14 shows an example of a method for SCell switching according to an embodiment of the present disclosure.

Referring to FIG. 14, in step S1401, UE may receive a configuration on an SCell and measurement configuration for the SCell.

The configuration may include a cell configuration for the SCell. Upon reception of the configuration, the UE may apply the configuration for the SCell.

The measurement configuration for the SCell may include the threshold to detect a link failure on the SCell. Upon reception of the measurement configuration, the UE may check if the signal quality of the SCell is below the threshold during measurement on the SCell.

In step S1403, UE may receive a configuration on a candidate cell and measurement configuration for the candidate cell.

The configuration may include all information for the candidate cell to work as an SCell. Upon receiving the configuration, the UE may store the configuration but doesn't apply it, i.e., doesn't consider the candidate cell as an SCell.

The configuration may also include information to indicate an association between the candidate cell and the SCell.

The network may give the association to the UE between the candidate cell and the SCell within same node, i.e., intra-node. Upon reception of the configuration, the UE may figure out which SCell should be switched to this candidate cell.

The measurement configuration for the candidate cell may include another threshold as a report condition for the case of a failure of the SCell.

Upon reception of the measurement configuration for the candidate cell, the UE may perform measurement for the candidate cell.

In step S1405, UE may detect a failure on the SCell. The UE may determine the failure of the SCell if the signal quality of the SCell is below the threshold of the measurement configuration for the SCell. The UE may not have an actual problem with data transmission via SCell, but the UE may regard the SCell as a cell that needs to be switched.

In step S1407, UE may report the failure on the SCell with candidate cell information.

After the failure on the SCell, the UE may check if the signalling quality of the candidate cell is above the another threshold as the report condition. If the signal quality of the candidate cell is above the another threshold, the UE may send MAC CE to indicate the failure of the SCell with candidate cell information which has the association with the SCell.

In step S1409, UE may receive, from a network, a command to switch from the SCell to the candidate cell for new SCell. The UE may receive a command to perform SCell switching from the network after sending the report of the SCell failure. The UE may apply the configuration that includes all information for the candidate cell and regard the candidate cell as a new SCell.

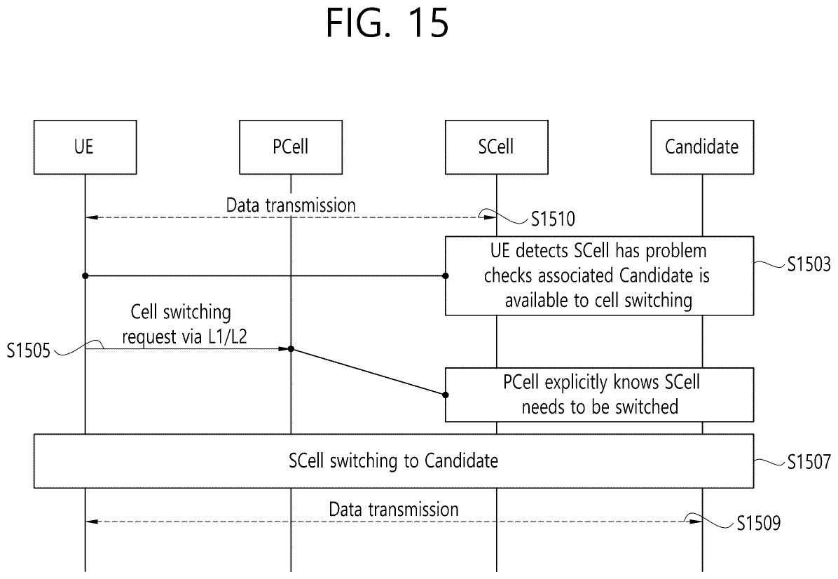

FIG. 15 shows a signal flow for SCell switching according to an embodiment of the present disclosure.

Referring to FIG. 15, in step S1501, UE may perform a data transmission with a serving SCell.

In step S1503, UE may detect a problem on the serving SCell. The UE may check whether there is an associated candidate SCell available to cell switching. For example, the UE may identify one or more candidate SCells associated with the serving SCell based on the association information, and evaluate report conditions for the one or more candidate SCells.

In step S1505, UE may transmit, to a PCell, a cell switching request via layer 1 (L1) and/or L2 signalling. The cell switching request may comprise at least one of an ID of the serving SCell, IDs of the one or more candidate SCells, measurement results of candidate SCells which satisfied the report condition, a TA status of the one or more candidate SCells, or an indication that the failure is detected on the serving SCell. Based on the cell switching request from the UE, the PCell may explicitly know that the serving SCell needs to be switched.

In step S1507, the UE may perform a SCell switching to a candidate SCell. The UE may receive, from the PCell, a switching command to the candidate SCell, and perform a SCell switching to the candidate SCell based on the switching command.

In step S1509, after switching to the candidate SCell, the UE may perform a data transmission with the candidate SCell, which is now a serving SCell.

Furthermore, the method in perspective of the UE described in the present disclosure (e.g., in FIG. 12) may be performed by the first wireless device 100 shown in FIG. 2 and/or the UE 100 shown in FIG. 3.

More specifically, the UE comprises at least one transceiver, at least processor, and at least one computer memory operably connectable to the at least one processor and storing instructions that, based on being executed by the at least one processor, perform operations.

The operations comprise: receiving, from a network via a special cell (SpCell), a configuration for one or more candidate secondary cells (SCells), wherein the configuration comprises association information informing one or more SCells associated with a corresponding candidate SCell, and at least one report condition for the corresponding candidate SCell; detecting a failure on a serving SCell; after detecting the failure on the serving SCell, identifying at least one candidate SCell associated with the serving SCell based on the association information; based on a report condition for a candidate SCell among the at least one candidate SCell being satisfied, transmitting report information comprising information for the candidate SCell to the network via the SpCell; receiving, from the network via the SpCell, a switching command to the candidate SCell after transmitting the report information; and applying a configuration for the candidate SCell based on the switching command.

Furthermore, the method in perspective of the UE described in the present disclosure (e.g., in FIG. 12) may be performed by a software code 105 stored in the memory 104 included in the first wireless device 100 shown in FIG. 2.

More specifically, at least one computer readable medium (CRM) stores instructions that, based on being executed by at least one processor, perform operations comprising: receiving, from a network via a special cell (SpCell), a configuration for one or more candidate secondary cells (SCells), wherein the configuration comprises association information informing one or more SCells associated with a corresponding candidate SCell, and at least one report condition for the corresponding candidate SCell; detecting a failure on a serving SCell; after detecting the failure on the serving SCell, identifying at least one candidate SCell associated with the serving SCell based on the association information; based on a report condition for a candidate SCell among the at least one candidate SCell being satisfied, transmitting report information comprising information for the candidate SCell to the network via the SpCell; receiving, from the network via the SpCell, a switching command to the candidate SCell after transmitting the report information; and applying a configuration for the candidate SCell based on the switching command.

Furthermore, the method in perspective of the UE described in the present disclosure (e.g., in FIG. 12) may be performed by control of the processor 102 included in the first wireless device 100 shown in FIG. 2 and/or by control of the processor 102 included in the UE 100 shown in FIG. 3.

More specifically, an apparatus configured to/adapted to operate in a wireless communication system (e.g., wireless device/UE) comprises at least processor, and at least one computer memory operably connectable to the at least one processor. The at least one processor is configured to/adapted to perform operations comprising: receiving, from a network via a special cell (SpCell), a configuration for one or more candidate secondary cells (SCells), wherein the configuration comprises association information informing one or more SCells associated with a corresponding candidate SCell, and at least one report condition for the corresponding candidate SCell; detecting a failure on a serving SCell; after detecting the failure on the serving SCell, identifying at least one candidate SCell associated with the serving SCell based on the association information; based on a report condition for a candidate SCell among the at least one candidate SCell being satisfied, transmitting report information comprising information for the candidate SCell to the network via the SpCell; receiving, from the network via the SpCell, a switching command to the candidate SCell after transmitting the report information; and applying a configuration for the candidate SCell based on the switching command.

Furthermore, the method in perspective of a network node described in the present disclosure (e.g., in FIG. 13) may be performed by the second wireless device 200 shown in FIG. 2.

More specifically, the network node comprises at least one transceiver, at least processor, and at least one computer memory operably connectable to the at least one processor and storing instructions that, based on being executed by the at least one processor, perform operations.

The operations comprise:
The present disclosure may have various advantageous effects.

For example, when the SCell is not available due to any (link) problem, the UE can request a fast SCell switching to the network based on the association between the current SCell and candidate cells. Through this request, pending data transmission can be reduced by the fast SCell switching requested by the UE.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method comprising:
receiving, from a network via a special cell (SpCell), a configuration for one or more candidate secondary cells (SCells), wherein the configuration comprises association information informing one or more SCells associated with a corresponding candidate SCell, and at least one report condition for the corresponding candidate SCell;
detecting a failure on a serving SCell;
after detecting the failure on the serving SCell, identifying at least one candidate SCell associated with the serving SCell based on the association information;
based on a report condition for a candidate SCell among the at least one candidate SCell being satisfied, transmitting report information comprising information for the candidate SCell to the network via the SpCell;
receiving, from the network via the SpCell, a switching command to the candidate SCell after transmitting the report information; and
applying a configuration for the candidate SCell based on the switching command.

2. The method of claim 1, wherein the at least one candidate SCell associated with the serving SCell is within at least one of:
a same node as the serving SCell;
a same cell group as the serving SCell; or
a same timing advance group (TAG) as the serving SCell, and
wherein the cell group comprises at least one of a master cell group (MCG) or a secondary cell group (SCG).

3. The method of claim 1, wherein the association information comprises the at least one report condition.

4. The method of claim 1, wherein the failure on the serving SCell is detected based on a signal quality of the serving SCell being lower than a failure detection threshold, and
wherein the failure detection threshold comprises at least one of:
a predetermined value;
a user equipment (UE)-specific value signaled or configured by the network; or
a cell-specific value broadcast by the network.

5. The method of claim 1, wherein the failure on the serving SCell is detected based on a number of beam failure instances detected for the serving SCell exceeding a beam failure detection threshold.

6. The method of claim 1, wherein the failure on the serving SCell is detected based on an expiry of a failure detection timer,
wherein the failure detection timer starts based on a number of states each in which a signal quality of the serving SCell is worse than a first threshold reaching a first threshold number, and
wherein the failure detection timer stops based on a number of states each in which a signal quality of the serving SCell is better than a second threshold reaching a second threshold number.

7. The method of claim 1, wherein the information for the candidate SCell comprises at least one of:
an identifier (ID) of the candidate SCell;
measurement results of the candidate SCell; or
a timing advance (TA) status of the candidate SCell.

8. The method of claim 1, wherein the report information further comprises at least one of:
an identifier (ID) of the serving SCell; or
an indication that the failure is detected on the serving SCell.

9. The method of claim 1, wherein the report information is transmitted to the network via a media access control (MAC) control element (CE) signalling.

10. The method of claim 1, further comprising:
obtaining measurement results for the at least one candidate SCell based on measurements on the at least one candidate SCell; and
performing an evaluation of a report condition for the at least one candidate SCell based on the measurement results for the at least one candidate SCell,
wherein the evaluation comprises determining whether the report condition for the at least one candidate SCell is satisfied, and
wherein the report condition for the at least one candidate SCell is satisfied based on the measurement results for the at least one candidate SCell satisfying a corresponding report condition.

11. The method of claim 10, further comprising determining a report condition for one or more candidate SCells other than the candidate SCell being satisfied based on the evaluation,
wherein the report information further comprises information for the one or more candidate SCells.

12. The method of claim 1, wherein the applying of the configuration for the candidate SCell comprises performing a switching to the candidate SCell from the serving SCell based on the switching command.

13. The method of claim 1, wherein the method is performed by a user equipment (UE) in communication with at least one of a mobile device, a network, or autonomous vehicles.

14. A user equipment (UE) comprising:
at least one transceiver;
at least one processor; and
at least one memory operatively coupled to the at least one processor and storing instructions that, based on being executed by the at least one processor, perform operations comprising:
receiving, from a network via a special cell (SpCell), a configuration for one or more candidate secondary cells (SCells), wherein the configuration comprises association information informing one or more SCells associated with a corresponding candidate SCell, and at least one report condition for the corresponding candidate SCell;
detecting a failure on a serving SCell;
after detecting the failure on the serving SCell, identifying at least one candidate SCell associated with the serving SCell based on the association information;
based on a report condition for a candidate SCell among the at least one candidate SCell being satisfied, transmitting report information comprising information for the candidate SCell to the network via the SpCell;
receiving, from the network via the SpCell, a switching command to the candidate SCell after transmitting the report information; and
applying a configuration for the candidate SCell based on the switching command.

15. (canceled)

16. A network node comprising:
at least one transceiver;
at least one processor; and
at least one memory operatively coupled to the at least one processor and storing instructions that, based on being executed by the at least one processor, perform operations comprising:
transmitting, to a user equipment (UE) via a special cell (SpCell), a configuration for one or more candidate secondary cells (SCells), wherein the configuration comprises association information informing one or more SCells associated with a corresponding candidate SCell, and at least one report condition for the corresponding candidate SCell;
after a failure is detected on a serving SCell, receiving, from the UE via the SpCell, report information comprising information for a candidate SCell based on a report condition for the candidate SCell being satisfied, wherein the candidate SCell is among at least one candidate SCell identified as being associated with the serving SCell based on the association information; and
transmitting, to the UE via the SpCell, a switching command to the candidate SCell after receiving the report information.

17-20. (canceled)
